(19) United States
(12) Patent Application Publication
(10) Pub. No.: US 2026/0318485 A1
(43) Pub. Date: Oct. 15, 2026

(54) DISCHARGE CHIMNEY

(71) Applicant: Linde GmbH, Pullach (DE)

(72) Inventors: Petya TONEVA, Pullach (DE); Anton WELLENHOFER, Pullach (DE)

(21) Appl. No.: 19/481,031

(22) PCT Filed: May 7, 2024
(86) PCT No.: PCT/EP2024/025157

§ 371 Date: Nov. 3, 2025

(30) Foreign Application Priority Data
May 8, 2023 (EP) 23020213.7

(51) Int. Cl. F17C 7/04

(52) U.S. Cl. CPC F17C 7/04; F17C 2201/0104; F17C 2203/0304; F17C 2203/0391; F17C 2203/0629; F17C 2205/0332; F17C 2221/011; F17C 2221/012; F17C 2221/014; F17C 2221/017; F17C 2223/0161; F17C 2270/0105

(57) ABSTRACT

A discharge chimney for discharging a cryogen, which has a liquid phase and a gaseous phase, into the surroundings of the discharge chimney, comprising a tubular chimney section, which extends along the direction of the gravitational force, wherein the interior of the discharge chimney is heat-insulated from the surroundings; a phase separator for separating the liquid phase from the gaseous phase; and an evaporator unit for evaporating the separated liquid phase.

The invention relates to a discharge chimney for discharging a cryogen, which has a liquid phase and a gaseous phase, into the surroundings of the discharge chimney.

During use of a storage container for hydrogen, it may be necessary to release hydrogen, in particular gaseous hydrogen, into the surroundings of the storage container. For this purpose, a discharge chimney can be provided according to internal company findings. Such a discharge chimney can, for example, be manufactured from a single-walled uninsulated steel pipe. When hydrogen is released into the surroundings, the outside of the discharge chimney may have a temperature below the condensation temperature of air components. This can lead to condensation or freezing of air components, in particular oxygen, on the outside of the discharge chimney.

The condensation of air components can lead to the formation of cryogenic liquid pools with high oxygen enrichment in the immediate surroundings of the discharge chimney. Dripping of the liquefied air components can result in cold embrittlement and material failure of low-alloy steel in the immediate surroundings of the discharge chimney. In addition, a high oxygen concentration in the immediate surroundings of the discharge chimney can lead to an increased risk of fire and/or explosion. This must be improved.

Against this background, it is an object of the present invention to provide an improved discharge chimney.

Accordingly, a discharge chimney is proposed for discharging a cryogen, which has a liquid phase and a gaseous phase, into the surroundings of the discharge chimney. The discharge chimney comprises a tubular chimney section, which extends along the direction of the gravitational force, wherein an inner wall of the tubular chimney section, said inner wall surrounding the interior of the discharge chimney, is heat-insulated from the surroundings, and wherein the tubular chimney section has a lower chimney section and an upper chimney section, wherein the upper chimney section has an outlet opening through which the upwardly rising gaseous phase exits into the surroundings; a phase separator, which is attached to the lower chimney section and is configured to separate the two-phase cryogen, which can be supplied via a line, into the liquid phase and the gaseous phase; and an evaporator unit for releasing heat to the interior in order to evaporate the separated liquid phase in the interior.

Because the interior of the discharge chimney is heat-insulated from the surroundings, condensation or freezing of air components on the outside of the discharge chimney is reliably prevented. This reduces in particular the risk of condensed air components dripping down from the discharge chimney.

The cryogen can be hydrogen. Therefore, the term “cryogen” can in the present case be replaced by the term “hydrogen”, and vice versa. However, the cryogen can also be liquid helium or the like. The discharge chimney can also be referred to as hydrogen discharge chimney. Preferably, the cryogen is supplied to the discharge chimney as a two-phase mixture comprising the liquid phase and the gaseous phase. The liquid phase is preferably liquid hydrogen. Accordingly, the term “liquid phase” can be replaced by the term “liquid hydrogen”, and vice versa. The gaseous phase is preferably gaseous hydrogen. Accordingly, the term “gaseous phase” can be replaced by the term “gaseous hydrogen”, and vice versa.

With the aid of the discharge chimney, the gaseous phase in particular can be released into the surroundings. To release the liquid phase into the surroundings, the liquid phase is first evaporated with the aid of the evaporator unit and released into the surroundings as a gaseous phase. The chimney section can be rotationally symmetrical with respect to an axis of symmetry or center axis. The discharge chimney can have multiple chimney sections, which can be arranged one above the other as viewed along the direction of the gravitational force.

In particular, the interior of the discharge chimney is heat-insulated from the surroundings such that it has low-temperature-stable insulation that is stable, for example, in a temperature range of −186 °C, which corresponds to the dew point of oxygen, and 3 K as the lowest temperature for helium as cryogen. The thermal insulation or heat insulation can be designed uniformly over the entire length of the discharge chimney. However, this is not mandatory. The simplest and cheapest solution for thermal insulation is double-walled vacuum insulation made of steel, in particular stainless steel.

With the aid of the phase separator, the two-phase mixture of the cryogen is fed into the interior of the discharge chimney. The gaseous phase separates from the liquid phase when the two-phase mixture enters the interior of the discharge chimney. The gaseous phase moves upward, in particular against the direction of the gravitational force, toward an outlet opening of the discharge chimney. The liquid phase moves downward, in particular along the direction of the gravitational force, toward a sump of the discharge chimney.

The phase separator can also be referred to as a trap, in particular as a phase trap. In particular, the phase separator is a gravity separator and can therefore also be referred to as such. The phase separator can also be referred to simply as a separator, in particular as a gravity separator. The phase separator can, for example, have the shape of a flange or T-piece, with the aid of which a line through which the two-phase mixture is supplied can be connected to the discharge chimney. The phase separator can be rotationally symmetrical with respect to an axis of symmetry or center axis. The center axis of the phase separator is oriented in particular perpendicularly to the center axis of the chimney section.

The phase separator is in particular configured to separate the two-phase mixture, which is supplied with the aid of the aforementioned line and comprises the liquid phase and the gaseous phase, into the liquid phase and the gaseous phase by gravity. The separation occurs in particular due to gravity. The liquid phase has a greater density than the gaseous phase, and therefore the liquid phase moves downward away from the outlet opening along the direction of the gravitational force, and the gaseous phase moves upward toward the outlet opening against the direction of the gravitational force.

The chimney section preferably has an evaporator unit receptacle for receiving the evaporator unit. This means in particular that the evaporator unit is attached to the chimney section, in particular to the lower chimney section. The evaporator unit can be a heat block. The evaporator unit is in particular suitable for emitting heat to the interior and thus to the liquid phase in order to evaporate the liquid phase. The evaporator unit can be heated electrically. For this purpose, the evaporator unit can, for example, be heated inductively, with the aid of a heating coil and/or with the aid of a heating conductor.

According to one embodiment, the chimney section is double-walled for thermal insulation.

The double-walled design of the chimney section means that cost-effective thermal insulation or heat insulation can be achieved. For example, the chimney section is manufactured from stainless steel.

According to a further embodiment, the chimney section has the inner wall facing the interior and an outer wall facing the surroundings, wherein a gap subjected to a vacuum is arranged between the inner wall and the outer wall.

Accordingly, the inner wall faces away from the surroundings, and the outer wall faces away from the interior. In the present case, “vacuum” is understood to mean in particular a pressure of less than 300 mbar, preferably less than 10-3 mbar, more preferably less than 10-7 mbar. The discharge chimney is therefore vacuum-insulated. A multilayered insulation element or a multilayered thermal insulation element can also be arranged in the gap. In particular, so-called multilayer insulation (MLI) can be arranged in the gap. In the event that high heat resistance is required, a heat-insulating glass foam, in particular a closed-cell glass foam, for example, can also be placed in the gap for thermal insulation.

According to a further embodiment, the phase separator and the evaporator unit are attached to the lower chimney section, wherein the phase separator is positioned above the evaporator unit as viewed along the direction of the gravitational force.

Accordingly, the evaporator unit is placed below the phase separator as viewed along the direction of the gravitational force. Thus, the liquid phase flows from the phase separator by gravity to the evaporator unit, where the liquid phase is evaporated into the gaseous phase.

According to a further embodiment, the lower chimney section has a sump closing the end of the chimney section, wherein the evaporator unit is positioned between the sump and the phase separator as viewed along the direction of the gravitational force.

The sump is therefore placed below the evaporator unit as viewed along the direction of the gravitational force. Water, for example, can condense in the sump and then be discharged from the sump. The sump can be pot-shaped or bowl-shaped. The sump is preferably also double-walled and thus heat-insulated.

According to a further embodiment, the discharge chimney has a condensate discharge line, which leads from the sump through the evaporator unit into the surroundings.

With the aid of the condensate discharge line, water, for example, from the sump can be discharged into the surroundings, in particular into a drain. The condensate discharge line can also be referred to as a drainage line. The condensate discharge line leads to a water separator or condensate separator of the discharge chimney.

According to a further embodiment, the discharge chimney has a condensate separator for separating water from the liquid phase, wherein the condensate discharge line leads to the condensate separator.

The condensate separator prevents in particular the release of the liquid phase and/or the gaseous phase into the surroundings. For example, the condensate separator can have a float switch that only floats on water. The condensate separator can be referred to as a water separator.

According to a further embodiment, the discharge chimney has a shut-off valve for shutting off and opening the condensate discharge line.

In particular, the shut-off valve is provided upstream of the condensate separator in or on the condensate discharge line. The condensate discharge line can be closed or opened using the shut-off valve. The shut-off valve can be integrated into the evaporator unit.

According to a further embodiment, the discharge chimney has a low temperature switch, which is integrated into the evaporator unit, for actuating the shut-off valve.

The low temperature switch can actuate the shut-off valve, for example to close and open it. For this purpose, an operative connection can be provided between the low temperature switch and the shut-off valve. The operative connection can be wireless or wired. The shut-off valve with the low temperature switch can be used to prevent the liquid phase from even entering the condensate separator.

According to a further embodiment, the evaporator unit has an outer side facing the surroundings and an inner side facing the interior.

Accordingly, the outer side faces away from the interior. The inner side therefore faces away from the surroundings. In particular, the evaporator unit can be suitable for transporting heat from the surroundings to the interior. In particular, the evaporator unit is dimensioned such that, during operation of the discharge chimney, a temperature on the outer side does not fall below a temperature below which air components condense when the inner side is in contact with the liquid phase. The evaporator unit is in particular insulated except for the outer side.

According to a further embodiment, the evaporator unit is configured to transport heat from the outer side to the inner side.

This means in particular that the evaporator unit is configured to transport heat from the surroundings to the interior in order to evaporate the liquid phase. Thus, the surroundings can be used as a heat source for the evaporator unit.

Preferably, the phase separator and the evaporator unit are attached to the lower chimney section, which is also referred to below as the first chimney section. The upper chimney section, which is also referred to below as the second chimney section, can also be called the chimney tip. Preferably, the second chimney section is fixedly connected to the first chimney section. The phase separator opens in particular into the first chimney section, which in particular also has the sump and the evaporator unit receptacle. Both the first chimney section and the second chimney section are preferably double-walled. This means that both the first chimney section and the second chimney section can each have an inner wall and an outer wall surrounding the inner wall. Between the inner wall and the outer wall there is a gap as mentioned above, which can be subjected to a vacuum. Thermal insulation can also be placed in the gap. The second chimney section is preferably fireproof. For this purpose, a fireproof insulating element, for example in the form of a glass foam, in particular a closed-cell glass foam, can be accommodated in the gap of the second chimney section.

According to a further embodiment, the second chimney section is thermally isolated from the first chimney section by means of a separator.

In particular, the first chimney section and the second chimney section are connected to one another with the aid of the separator. The connection between the first chimney section and the second chimney section can be detachable.

According to a further embodiment, the second chimney section has a cross-sectional constriction provided at the outlet opening.

The cross-sectional constriction can be achieved, for example, by reducing an outer diameter and/or an inner diameter of the second chimney section toward the outlet opening. As a result, the outlet opening has a diameter that is smaller than the outer diameter and/or the inner diameter of the second chimney section. With the aid of the cross-sectional constriction, the gaseous phase can be accelerated as it exits from the outlet opening. Any air components that may have condensed are then entrained by the exiting gaseous phase. The condensed air components are prevented from accumulating and dripping down.

According to a further embodiment, the second chimney section has a flow-diverting body, which is arranged downstream of the outlet opening.

In this case, “downstream” is to be understood in relation to a flow direction of the gaseous phase exiting from the outlet opening. This means in particular that the flow-diverting body is placed at a defined distance in front of the outlet opening. The flow-diverting body prevents, for example, water or snow from entering the outlet opening. The flow-diverting body can be rotationally symmetrical to an axis of symmetry or center axis. The center axis of the flow-diverting body can coincide with the center axis of the chimney section. Preferably, the flow-diverting body has a frustoconical or conical front side facing the outlet opening and a rear side facing away from the outlet opening. For example, the rear side can be flat or curved. The flow-diverting body further has a diameter that is equal to or smaller than the outer diameter of the second chimney section and preferably larger than the diameter of the outlet opening. The flow-diverting body can be supported on the second chimney section, in particular on the cross-sectional constriction, by multiple struts. The struts support the flow-diverting body.

In the present case, “a(n)” is not necessarily to be understood as limiting to exactly one element. It is rather the case that a plurality of elements, such as two, three, or more, may also be provided. Any other numerical word used herein is also not to be understood as meaning an exact limitation to exactly the corresponding number of elements. Rather, numerical differences upwards or downwards are possible.

Further possible implementations of the discharge chimney also comprise not explicitly mentioned combinations of features or embodiments described above or below with respect to the exemplary embodiments. A person skilled in the art will also add individual aspects as improvements or additions to the particular basic form of the discharge chimney.

Further advantageous embodiments of the discharge chimney form the subject matter of the dependent claims and of the exemplary embodiments of the discharge chimney described below. The discharge chimney is explained in more detail below using preferred embodiments with reference to the attached drawings.

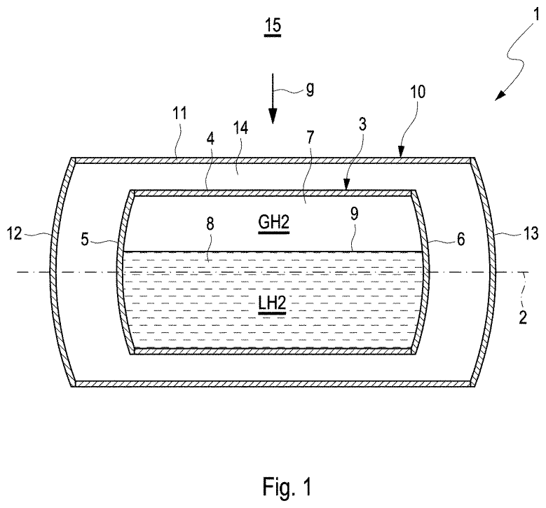

FIG. 1 shows a schematic sectional view of an embodiment of a storage container;

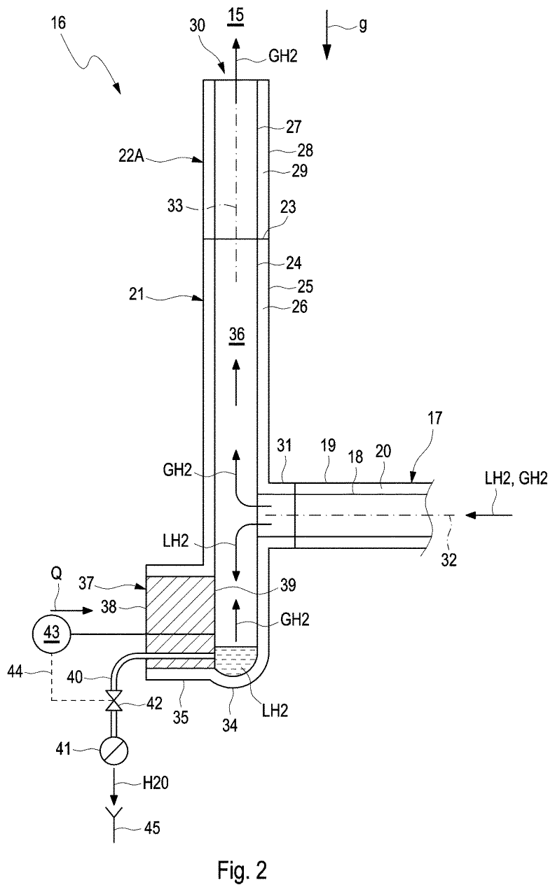

FIG. 2 shows a schematic sectional view of an embodiment of a discharge chimney for the storage container according to FIG. 1; and

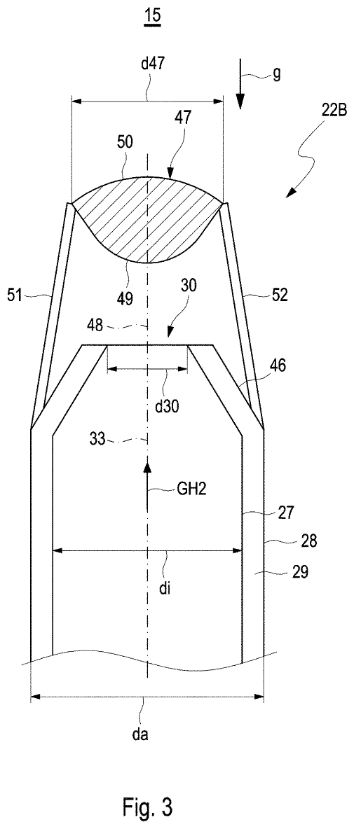

FIG. 3 shows a schematic sectional view of an embodiment of a chimney section for the discharge chimney according to FIG. 2.

In the figures, the same or functionally equivalent elements have been provided with the same reference signs unless otherwise indicated.

FIG. 1 shows a schematic sectional view of an embodiment of a storage container 1.

The storage container 1 can also be referred to as a storage tank. The storage container 1 is preferably suitable for holding hydrogen H2 (boiling point 1 bar absolute: 20.268 K=−252.882 °C). The storage container 1 can therefore also be referred to as a hydrogen storage container or as a hydrogen storage tank. However, the storage container 1 can also be used for other cryogenic liquids. Examples of cryogenic fluids or liquids, or cryogens for short, in addition to the aforementioned hydrogen H2 are liquid helium He (boiling point at 1 bar absolute: 4.222 K=−268.928 °C), liquid nitrogen N2 (boiling point at 1 bar absolute: 77.35 K=−195.80 °C) or liquid oxygen O2 (boiling point at 1 bar absolute: 90.18 K=−182.97 °C).

The storage container 1 can be a transport container. For example, liquid hydrogen LH2 can be transported with the storage container 1. The storage container 1 can be part of a vehicle, in particular a watercraft. In this case, the storage container 1 is suitable for mobile applications. However, the storage container 1 can also be used in a stationary manner, for example in building technology.

The storage container 1 is rotationally symmetrical with respect to an axis of symmetry or center axis 2. The center axis 2 is oriented in particular perpendicularly to the direction of the gravitational force g. The storage container 1 comprises a first container or inner container 3 which is also constructed rotationally symmetrically to the center axis 2. The inner container 3 comprises a tubular or cylindrical base section 4, which also has a rotationally symmetrical design in relation to the center axis 2. In cross section, the base section 4 can have a circular or approximately circular geometry.

The base section 4 is closed at both ends with the aid of a cover section 5, 6. The cover sections 5, 6 are domed. A first cover section 5 and a second cover section 6 are domed in opposite directions so that the two cover sections 5, 6 are domed outward in relation to the base section 4. The inner container 3 is fluid-tight, in particular gas-tight. The inner container 3 is manufactured from steel.

The liquid hydrogen LH2 is held in the inner container 3. As long as the hydrogen H2 is in the two-phase region, a gas zone 7 containing gaseous hydrogen GH2 and a liquid zone 8 containing liquid hydrogen LH2 can be provided in the inner container 3. After entering the inner container 3, the hydrogen H2 therefore has two phases with different aggregate states, namely, liquid and gaseous. That is to say, in the inner container 3 there is a phase boundary 9 between the liquid hydrogen LH2 and the gaseous hydrogen GH2. The gaseous hydrogen GH2 can also be referred to as the gaseous phase. The liquid hydrogen LH2 can also be referred to as the liquid phase.

The inner container 3 is arranged completely within a second container or outer container 10. The storage container 1 is therefore double-walled. The outer container 10 is also rotationally symmetrical in relation to center axis 2. The outer container 10, like the inner container 3, comprises a tubular or cylindrical base section 11 which is rotationally symmetrical in relation to the center axis 2. In cross section, the base section 11 can have a circular or approximately circular geometry.

The base section 11 is closed off at the ends in each case by a cover section 12, 13. In particular, a first cover section 12 and a second cover section 13 are provided. The cover sections 12, 13 are domed in opposite directions so that the cover sections 12, 13 are domed outward in relation to the base section 11. The outer container 10 is fluid-tight, in particular gas-tight. The outer container 10 can also be made of stainless steel, for example.

A gap 14 completely surrounding or encompassing the inner container 3 is provided between the inner container 3 and the outer container 10. The gap 14 is subjected to a vacuum. In the present case, “vacuum” is understood to mean in particular a pressure of less than 300 mbar, preferably less than 10-3 mbar, more preferably less than 10-7 mbar. The storage container 1 is therefore vacuum-insulated. The fact that the gap 14 completely “encompasses” or “encases” the inner container 3 means in the present case that the gap 14, on the one hand, runs completely around the base section 4 and, on the other hand, is also provided between the two cover sections 5, 12 as well as between the two cover sections 6, 13.

A thermal insulation element or insulating element (not shown), which completely encompasses or surrounds the inner container 3, is provided in the gap 14. That is to say, the insulation element encloses not only the base section 4 but also the cover sections 5, 6 of the inner container 3. The insulation element serves for thermal insulation. The insulation element is multilayered. This means that the insulation element comprises a plurality of layers. The insulation element can therefore also be referred to as a multilayered insulation element or a multilayered thermal insulation element. In particular, the insulation element is a so-called multilayer insulation (MLI).

During operation of the storage container 1, for example when it is transported, it may be necessary to release hydrogen H2, in particular gaseous hydrogen GH2, but also liquid hydrogen LH2, into the surroundings 15 of the storage container 1. For this purpose, a discharge chimney can be provided, which is connected to the storage container 1 by means of a line. According to internal company findings, such an uninsulated discharge chimney for the discharge of gases with temperatures above the liquefaction temperature of air components is a common technical solution.

At temperatures of the hydrogen H2 released into the surroundings 15 via the discharge chimney below the condensation temperature of the air components, condensation or freezing of air components can occur on the discharge chimney. This can lead to the formation of cryogenic liquid pools with high oxygen enrichment in the immediate surroundings of the discharge chimney. Dripping of the liquefied air components can result in cold embrittlement and material failure of low-alloy steel in the immediate surroundings of the discharge chimney. In addition, a high oxygen concentration in the immediate surroundings of the discharge chimney can lead to an increased risk of fire and/or explosion. This must be improved.

FIG. 2 shows a schematic sectional view of an embodiment of a discharge chimney 16 for the storage container 1.

The discharge chimney 16 can be referred to as a gas discharge chimney. The discharge chimney 16 can be part of the storage container 1. However, this is not mandatory. The discharge chimney 16 together with the storage container 1 can form a storage container arrangement. The storage container arrangement comprises the storage container 1, a line 17 coming from a collector or a so-called header of the storage container 1, and the discharge chimney 16 itself. The header can be part of the storage container 1. The header can be or have a collection system for collecting hydrogen H2 exiting from the storage container 1. The header can also have safety and/or relief valves, for example.

The line 17 can be double-walled and have an inner wall 18 and an outer wall 19 surrounding the inner wall 18. The inner wall 18 and the outer wall 19 are each tubular. A gap 20 can be provided between the inner wall 18 and the outer wall 19. The gap 20 can be subjected to a vacuum. The line 17 can thereby be heat-insulated or insulated with the aid of the gap 20. An MLI or other insulating material as mentioned above can also be accommodated in the gap 20.

A two-phase mixture comprising liquid hydrogen LH2 and gaseous hydrogen GH2, which comes from the storage container 1, in particular from the header, can be supplied to the discharge chimney 16 via the line 17. The line 17 can be oriented perpendicularly to the direction of the gravitational force g.

The discharge chimney 16 has a lower or first chimney section 21 and an upper or second chimney section 22A arranged above the first chimney section 21 along the direction of the gravitational force g. An optional separator 23 can be provided between the first chimney section 21 and the second chimney section 22A. The discharge chimney 16 is therefore in two parts. With the aid of the separator 23, the second chimney section 22A can be thermally isolated from the first chimney section 21. The second chimney section 22A can also be referred to as the chimney tip.

The first chimney section 21 is double-walled and comprises an inner wall 24 and an outer wall 25 surrounding the inner wall 24. A gap 26 is provided between the inner wall 24 and the outer wall 25. The gap 26 can be subjected to a vacuum. As a result, the first chimney section 21 can be heat-insulated or insulated with the aid of the gap 26. An MLI or other insulating material as mentioned above can also be accommodated in the gap 26. The inner wall 24 and the outer wall 25 can be manufactured from stainless steel.

The second chimney section 22A is also double-walled and comprises an inner wall 27 and an outer wall 28 surrounding the inner wall 27. A gap 29 is provided between the inner wall 27 and the outer wall 28. The gap 29 can be subjected to a vacuum. As a result, the second chimney section 22A can be heat-insulated or insulated with the aid of the gap 29. The gap 29 can also be filled at least in sections with glass foam, in particular with closed-cell glass foam.

The second chimney section 22A is tubular and comprises an outlet opening 30 from which gaseous hydrogen GH2 exits during operation of the discharge chimney 16. The gaseous hydrogen GH2 can, for example, be burned at the outlet opening 30. The second chimney section 22A runs along the direction of the gravitational force g. The inner wall 27 and the outer wall 28 can be manufactured from stainless steel.

In the orientation of FIG. 2, the outlet opening 30 is upwardly open. There are no free surfaces for the formation of air condensate or the deposition of snow. The objective as the gaseous hydrogen GH2 flows out of the outlet opening 30 is to ensure that no air ice forms. This can be achieved in particular by a high exit velocity of the gaseous hydrogen GH2 from the outlet opening 30.

The first chimney section 21 is also tubular and runs along the direction of the gravitational force g. A separator, in particular a phase separator 31, is attached to the first chimney section 21. The phase separator 31 is a gravity separator and can therefore also be referred to as such. The phase separator 31 can also be referred to simply as a separator, in particular as a gravity separator. The phase separator 31 preferably has the shape of a flange or T-piece, with the aid of which the line 17 can be connected to the discharge chimney 16.

The phase separator 31 can be rotationally symmetrical with respect to an axis of symmetry or center axis 32. The discharge chimney 16 itself or the chimney sections 21, 22A can also be rotationally symmetrical with respect to an axis of symmetry or center axis 33. The center axis 32 is oriented perpendicularly to the center axis 33.

The phase separator 31 is suitable for separating the two-phase mixture, which is supplied with the aid of the line 17 and comprises liquid hydrogen LH2 and gaseous hydrogen GH2, into the liquid hydrogen LH2 and the gaseous hydrogen GH2. The separation occurs due to gravity. The liquid hydrogen LH2 has a greater density than the gaseous hydrogen GH2, and therefore the liquid hydrogen LH2 moves downward along the direction of the gravitational force g, and the gaseous hydrogen GH2 moves upward against the direction of the gravitational force g.

The line 17 is fluid-tightly connected to the phase separator 31. The phase separator 31 is also double-walled. Viewed along the direction of the gravitational force g, a sump 34 of the first chimney section 21 is provided below the phase separator 31. The sump 34 can be pot-shaped or bowl-shaped. The sump 34 is also double-walled.

An evaporator unit receptacle 35 adjoins the sump 34. The evaporator unit receptacle 35 is also double-walled. Viewed along the direction of the gravitational force g, the evaporator unit receptacle 35 is positioned between the sump 34 and the phase separator 31. The first chimney section 21 and the second chimney section 22A together enclose an interior 36 of the discharge chimney 16. The interior 36 can be cylindrical, in particular circular-cylindrical.

An evaporator unit 37, in particular in the form of a heat block, is accommodated in the evaporator unit receptacle 35. The evaporator unit 37 is suitable for emitting heat Q to the interior 36 in order to evaporate liquid hydrogen LH2. The evaporator unit 37 can be heated electrically. For this purpose, the evaporator unit 37 can be heated inductively, with the aid of a heating coil and/or with the aid of a heating conductor.

The evaporator unit 37 has an outer side 38 facing the surroundings 15 and an inner side 39 facing the interior 36. Accordingly, the outer side 38 faces away from the interior 36. The inner side 39 faces away from the surroundings 15. In particular, the evaporator unit 37 can also be suitable for transporting heat Q from the outer side 38 to the inner side 39 and thus also from the surroundings 15 to the interior 36.

The evaporator unit 37 is dimensioned such that, during operation of the discharge chimney 16, a temperature on the outer side 38 does not fall below a temperature below which air components condense when the inner side 39 is in contact with liquid hydrogen LH2. The evaporator unit 37 is insulated except for the outer side 38.

A drainage line or condensate discharge line 40 leads through the evaporator unit 37. The condensate discharge line 40 leads from the interior 36 to the surroundings 15. The condensate discharge line 40 leads to a water separator or condensate separator 41. The condensate separator 41 prevents the release of liquid hydrogen LH2 and/or gaseous hydrogen GH2. For example, the condensate separator 41 can have a float switch that only floats on water H2O.

Upstream of the condensate separator 41, a shut-off valve 42 can be provided in or on the condensate discharge line 40. The condensate discharge line 40 can be closed or opened using the shut-off valve 42. The shut-off valve 42 can be integrated into the evaporator unit 37.

Optionally, a low temperature switch 43 can be installed in the evaporator unit 37. The low temperature switch 43 can actuate the shut-off valve 42, for example to selectively close or open it. For this purpose, an operative connection 44 can be provided between the low temperature switch 43 and the shut-off valve 42. The operative connection 44 can be wireless or wired. With the aid of the condensate separator 41, water H2O can be separated out and supplied to a drain 45.

The operating principle of the discharge chimney 16 is explained below. As previously mentioned, a cold two-phase mixture of liquid hydrogen LH2 and gaseous hydrogen GH2 is supplied to the discharge chimney 16 in a surge-like manner via the line 17. The two-phase mixture comprising liquid hydrogen LH2 and gaseous hydrogen GH2 enters the interior 36 via the phase separator 31. There, the phase separator 31 separates the two-phase mixture so that the gaseous hydrogen GH2 rises upward against the direction of the gravitational force g and exits from the outlet opening 30 into the surroundings 15. The gaseous hydrogen GH2 can be burned at the outlet opening 30.

The liquid hydrogen LH2 flows from the phase separator 31 along the direction of the gravitational force g downward into the sump 34. With the aid of the heat Q supplied via the evaporator unit 37, the liquid hydrogen LH2 is evaporated and rises upward as gaseous hydrogen GH2 against the direction of the gravitational force g to exit from the outlet opening 30.

The gaseous hydrogen GH2 displaces the air in the interior 36. As soon as all of the liquid hydrogen LH2 has evaporated, the interior 36 fills with air again, which is then displaced from the interior 36 when hydrogen H2 is supplied again to the discharge chimney 16. The discharge chimney 16 is designed in particular to withstand the ignition of oxyhydrogen gas, a mixture of oxygen and gaseous hydrogen GH2, in the interior 36.

With the aid of the double-walled design of the discharge chimney 16, cryogenic temperatures on the outside of the discharge chimney 16 and thus condensation or freezing of air components on the outside of the discharge chimney 16 are prevented. An additional barrier can be provided for this purpose. This additional barrier can be realized by dividing the discharge chimney 16 at the separator 23 into the first chimney section 21 and the second chimney section 22A. Furthermore, vacuum insulation can be realized with the aid of the gaps 26, 29 both on the first chimney section 21 and on the second chimney section 22A.

On the discharge chimney 16 there can thus be low-temperature-stable insulation that is stable in a temperature range of −186 °C, which is the dew point of oxygen, and 3 K as the lowest temperature for helium. The insulation can be designed uniformly over the entire length of the discharge chimney 16. The cheapest solution is a double-walled vacuum insulation made of steel.

The second chimney section 22A can be fireproof. Preferably, the second chimney section 22A has no non-metallic installations and/or no non-metallic insulation in its gap 29, since non-metallic installations are potentially not heat-resistant. However, as previously mentioned, the gap 29 can be filled, for example, with glass foam, perlite or other low-temperature-resistant and simultaneously high-temperature-resistant fill materials.

The liquid hydrogen LH2 that reaches the discharge chimney 16 is advantageously evaporated at low temperature at the evaporator unit 37. Due to the low evaporation temperature of liquid hydrogen LH2, the surroundings 15 are suitable as a heat source. The evaporator unit 37 can function as an external heat store. The evaporator unit 37 is preferably manufactured from stainless steel. In particular, the evaporator unit 37 is designed such that, on the one hand, it serves as a heat store and, on the other hand, its design ensures that temperatures on the outer side 38 of the evaporator unit 37 do not fall below those at which air components condense. An inherently safe and new design can thereby be realized.

An additional safety measure that can be taken is to protect the surroundings 15 from a possible escape of liquid hydrogen LH2 at the sump 34, in particular at the condensate separator 41. In order to reliably prevent the escape of liquid hydrogen LH2, multiple measures can be taken.

As one measure, the condensate separator 41 can be designed such that it remains closed in the presence of liquid hydrogen LH2. As previously mentioned, the condensate separator 41 can have a float switch that floats only on water H20 and not on liquid hydrogen LH2. This functionality is based on the fact that the density of liquid hydrogen LH2, at approximately 70kg/m3, is significantly lower than the density of water, at approximately 1000kg/m3. As an additional measure, the shut-off valve 42 with the low temperature switch 43 can be used to prevent liquid hydrogen LH2 from even entering the condensate separator 41.

The previously explained design of the discharge chimney 16 allows the installation of the discharge chimney 16 in the immediate vicinity of safety valves of the storage container 1. This means that no long outlet lines from the safety valves to the discharge chimney 16 are required to heat the hydrogen H2 by heat conduction from the surroundings 15 before it reaches the discharge chimney 16. Stationary heating is carried out by the external evaporator unit 37. The evaporator unit 37 can be used as a circulation evaporator.

A double-walled design of the outlet lines of the safety valves is made possible, thus ensuring that in the event of a leak in one of the outlet lines, the hydrogen H2 is captured by a secondary barrier of the outlet lines and does not escape into the immediate surroundings 15. This is important in the case of below-deck installation of hydrogen equipment or installation in enclosed spaces.

FIG. 3 shows a schematic sectional view of a further embodiment of a second chimney section 22B as mentioned above.

All previous statements concerning the first chimney section 22A are correspondingly applicable to the second chimney section 22B, and vice versa. The second chimney section 22B according to FIG. 3 differs from the previously explained embodiment of the second chimney section 22A in that the second chimney section 22B is tapered at the outlet opening 30 and has a cross-sectional constriction 46. The cross-sectional constriction 46 can be achieved, for example, by an outer diameter da and/or an inner diameter di of the second chimney section 22B decreasing toward the outlet opening 30.

Due to the cross-sectional constriction 46, the outlet opening 30 has a diameter d30 that is smaller than the inner diameter di of the second chimney section 22B. With the aid of the cross-sectional constriction 46, the gaseous hydrogen GH2 can be accelerated as it exits from the outlet opening 30.

Optionally, the second chimney section 22B can have a flow-diverting body 47, which is placed at a distance in front of the outlet opening 30. The flow-diverting body 47 prevents water H2O or snow from entering the outlet opening 30. The flow-diverting body 47 can be rotationally symmetrical with respect to an axis of symmetry or center axis 48. The center axis 48 can coincide with the center axis 33.

The flow-diverting body 47 has a frustoconical or conical front side 49 facing the outlet opening 30 and a rear side 50 facing away from the outlet opening 30. The rear side 50 can be curved. The flow-diverting body 47 further has a diameter d47 that is equal to or smaller than the outer diameter da and larger than the diameter d30. The flow-diverting body 47 can be supported on the second chimney section 22B, in particular on the cross-sectional constriction 46, by multiple struts 51, 52. The struts 51, 52 support the flow-diverting body 47.

Although the present invention has been described with reference to embodiments, it can be modified in many ways within the scope of the claims.

### REFERENCE SIGNS USED

1 Storage container
2 Center axis
3 Inner container
4 Base section
5 Cover section
6 Cover section
7 Gas zone
8 Liquid zone
9 Phase boundary
10 Outer container
11 Base section
12 Cover section
13 Cover section
14 Gap
15 Surroundings
16 Discharge chimney
17 Line
18 Inner wall
19 Outer wall
20 Gap
21 Chimney section
22A Chimney section
22B Chimney section
23 Separator
24 Inner wall
25 Outer wall
26 Gap
27 Inner wall
28 Outer wall
29 Gap
30 Outlet opening
31 Phase separator
32 Center axis
33 Center axis
34 Sump
35 Evaporator unit receptacle
36 Interior
37 Evaporator unit
38 Outer side
39 Inner side
40 Condensate discharge line
41 Condensate separator
42 Shut-off valve
43 Low temperature switch
44 Operative connection
45 Drain
46 Cross-sectional constriction
47 Flow-diverting body
48 Center axis
49 Front side
50 Rear side
51 Strut
52 Strut
da Outer diameter
di Inner diameter
d30 Diameter
d47 Diameter
g Direction of the gravitational force
GH2 Cryogen/hydrogen
H2 Cryogen/hydrogen
H2O Water
LH2 Cryogen/hydrogen
Q Heat

1. A discharge chimney for discharging a cryogen, which has a liquid phase and a gaseous phase, into the surroundings of the discharge chimney, having
a tubular chimney section, which extends along the direction of the gravitational force wherein an inner wall of the tubular chimney section, said inner wall surrounding the interior of the discharge chimney, is heat-insulated from the surroundings and wherein the tubular chimney section has a lower chimney section and an upper chimney section wherein the upper chimney section has an outlet opening through which the upwardly rising gaseous phase exits into the surroundings,
a phase separator which is attached to the lower chimney section and is configured to separate the two-phase cryogen, which can be supplied via a line into the liquid phase and the gaseous phase, and
an evaporator unit for releasing heat to the interior in order to evaporate the separated liquid phase in the interior.

2. The discharge chimney according to claim 1, wherein the chimney section is double-walled for thermal insulation.

3. The discharge chimney according to claim 1, wherein the chimney section has the inner wall facing the interior and an outer wall facing the surroundings and wherein a gap subjected to a vacuum is arranged between the inner wall and the outer wall.

4. The discharge chimney according to claim 1, wherein the evaporator unit is attached to the lower chimney section and wherein the phase separator is positioned above the evaporator unit as viewed along the direction of the gravitational force.

5. The discharge chimney according to claim 1, wherein the lower chimney section has a sump closing the end of the lower chimney section, and wherein the evaporator unit is positioned between the sump and the phase separator as viewed along the direction of the gravitational force.

6. The discharge chimney according to claim 1, further having a condensate discharge line which leads from the sump through the evaporator unit into the surroundings.

7. The discharge chimney according to claim 6, further having a condensate separator for separating water from the liquid phase wherein the condensate discharge line leads to the condensate separator.

8. The discharge chimney according to claim 7, further having a shut-off valve for shutting off and opening the condensate discharge line

9. The discharge chimney according to claim 8, further having a low temperature switch, which is integrated into the evaporator unit, for actuating the shut-off valve.

10. The discharge chimney according to claim 1, wherein the evaporator unit has an outer side facing the surroundings and an inner side facing the interior.

11. The discharge chimney according to claim 10, wherein the evaporator unit is configured to transport heat from the outer side to the inner side.

12. The discharge chimney according to claim 1, wherein the upper chimney section is thermally isolated from the lower chimney section by means of a separator.

13. The discharge chimney according to one of claim 1, wherein the upper chimney section has a cross-sectional constriction provided at the outlet opening.

14. The discharge chimney according to claim 1, wherein the upper chimney section has a flow-diverting body which is arranged downstream of the outlet opening.

15. The discharge chimney according to claim 1, wherein the upper chimney section is fireproof.

16. The discharge chimney according to claim 2, wherein the chimney section has the inner wall facing the interior and an outer wall facing the surroundings, and wherein a gap subjected to a vacuum is arranged between the inner wall and the outer wall.

17. The discharge chimney according to claim 2, wherein the evaporator unit is attached to the lower chimney section, and wherein the phase separator is positioned above the evaporator unit as viewed along the direction of the gravitational force.

18. The discharge chimney according to claim 3, wherein the evaporator unit is attached to the lower chimney section, and wherein the phase separator is positioned above the evaporator unit as viewed along the direction of the gravitational force.

19. The discharge chimney according to claim 2, wherein the lower chimney section has a sump closing the end of the lower chimney section, and wherein the evaporator unit is positioned between the sump and the phase separator as viewed along the direction of the gravitational force.

20. The discharge chimney according to claim 3, wherein the lower chimney section has a sump closing the end of the lower chimney section, and wherein the evaporator unit is positioned between the sump and the phase separator as viewed along the direction of the gravitational force.
